(19) United States
(12) Patent Application Publication
(10) Pub. No.: US 2024/0046175 A1
(43) Pub. Date: Feb. 8, 2024

(54) SYSTEMS AND METHODS FOR DETERMINING AND VISUALIZING EMPLOYEE ENGAGEMENT

(71) Applicant: Genpact Luxembourg S.à r.l. II, Luxembourg (LU)

(72) Inventor: Prasenjit Ghosh, Bangalore (IN)

(21) Appl. No.: 17/882,982

(22) Filed: Aug. 8, 2022

(51) Int. Cl. G06Q 10/06

(52) U.S. Cl. CPC G06Q 10/063118; G06Q 10/06398

(57) ABSTRACT

The disclosure relates to a method for determining an employee engagement index score of an employee in an organization, the method including receiving a plurality of influencer scores for a plurality of employee; receiving a plurality of weightages for each of the plurality of influencer scores, the plurality of weightages defined by the organization; generating an employee engagement index score for each employee based on the plurality of weightages and the plurality of influencer scores associated with the employee; generating a graphical user interface that displays output data comprising the employee engagement index score of each employee and a category associated with each employee.

### TECHNICAL FIELD

The present systems and methods are directed to systems and methods for determining and visualizing employee engagement through a graphical user interface.

### BACKGROUND

The mass exodus of employees that began during the pandemic shows no sign of slowing down. This one-of-a-kind phenomenon is called the great resignation. Experts predict that the attrition percentage may hit as high as 40% globally. One popular belief for the sudden shift in the market is that we have entered an era of heightened self-awareness. Employees are increasingly questioning the meaning and the purpose of their work life. In addition, global talent shortage has been at an all-time high. Despite competitive offers, employee retention is low. Therefore, there is a need to get to the root of the problem, which is employee engagement.

### SUMMARY

In one aspect, the subject matter of this disclosure relates to a system for generating an employee engagement recommender model for determining an employee engagement index score of an employee in an organization, the system including one or more processors; and a memory coupled with the one or more processors wherein the one or more processors executes a plurality of modules stored in the memory and wherein the plurality of modules may include a user input module that, when executed, receives input data including a plurality of weightages and a plurality of influencer scores for a plurality of employees, an employee engagement recommender module that, when executed, generates an employee engagement index score for each employee based on the one or more weightages and one or more of the influencer scores associated with the employee, a user interface module that, when executed, generates a graphical user interface that displays output data including the employee engagement index score of each employee and a category associated with each employee, wherein the graphical user interface may be configured to (i) create and display an employee engagement user interface element for each employee by positioning within the graphical user interface an identifier associated with such employee in correlation with a visual representation of the employee engagement index score of such employee and a visual representation of the associated category of such employee and (ii) spatially arraying the employee engagement user interface elements within the graphical user interface to facilitate comparison of the plurality of employees. A user of the system may manually input the one or more weightages and the one or more influencer scores. A third party system may provide the one or more weightages, the third party system including data regarding the organization. The one or more categories for the one or more employees may include a champion category, a neutral positive category, and a potential churn category. Each of the one or more employment engagement index scores may have a corresponding category in the one or more categories for the one or more employees. Each of the one or more categories may have a color different than each other category in the one or more categories. The pre-set value may be determined by a user of the system. The pre-set value may be determined by a third party system, the third party system including data regarding the organization. One or more action plans may be suggested based on the one or more categories. The employee recommender module may further generate a value by multiplying each of the one or more influencer scores by each associated weightage of the one or more weightages. The employee recommender module may further generates the employee engagement index score by subtracting the value from a pre-set value.

In one aspect, the subject matter of this disclosure relates to a method for determining an employee engagement index score of an employee in an organization, the method including receiving, by a processor, a plurality of influencer scores for a plurality of employee; receiving, by the processor, a plurality of weightages for each of the plurality of influencer scores, the plurality of weightages defined by the organization; generating, by the processor, an employee engagement index score for each employee based on the plurality of weightages and the plurality of influencer scores associated with the employee; generating, by the processor, a graphical user interface that displays output data comprising the employee engagement index score of each employee and a category associated with each employee. A user may manually input the plurality of weightages and the plurality of influencer scores. A third party system may provide the plurality of weightages, the third party system including data regarding the organization. The category may be in one or more categories for the employee, the one or more categories including a champion category, a neutral positive category, and a potential churn category. Each of the one or more categories may have a color different than other category in the one or more categories. One or more action plans may be suggested based on the one or more categories. The pre-set value may be determined by a user or by a third party system, the third party system including data regarding the organization.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 illustrates a table of symbolic representation of input parameters of an employment engagement recommender (E2R) model including concerns about influencers, influencer scores, and one or more criteria for the influencer scores, according to various embodiments of the present disclosure;

FIG. 2 illustrates a table of symbolic representation of weightages for one or more concerns about influencers in the E2R model, according to various embodiments of the present disclosure;

FIG. 3 illustrates a calculation of employee engagement index (E2I) score and an E2I score scale is shown, according to various embodiments of the present disclosure;

FIG. 4 illustrates a table including one or more employees with employee engagement index (E2I) score, according to various embodiments of the present disclosure;

FIG. 5 illustrates a table including one or more categories with a suggested action plan for an employee, according to various embodiments of the present disclosure;

FIG. 6 illustrates a graphical user interface (GUI) including the weightage, the influencer score, and the E2I score, according to various embodiments of the present disclosure;

FIG. 7 illustrates a flowchart diagram of generating an employee engagement index is shown, according to various embodiments of the present disclosure; and

FIG. 8 illustrates a schematic diagram of a generic computer system, according to various embodiments of the present disclosure.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel. Any dimension or example part called out in the figures are examples only, and the example embodiments described herein are not so limited.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

With reference to the drawings, the invention will now be described in more detail. The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

In one embodiment, a determination of employee engagement may be used to solve the low employee retention problem. In the present disclosure, an employee engagement recommender (E2R) model may be used. The E2R model may help a company or an organization to evaluate employee engagement to address low employee retention and the mass exodus of employees. The E2R model is flexible and may fine-tune parameters to quantify employee engagement.

In one embodiment, the E2R model is a plug-and-play model that empowers users to capture insights without worrying about complexities. What makes the E2R model function-friendly is the ability to freely customize it. The E2R model helps human resources function to become a strategic unit within an organization by identifying problems and formulating action plans, and further by achieving an optimum level of employee engagement.

In one embodiment, the E2R model may also be scaled for cross-functional use cases. For example, a project account manager may use the E2R model to gauge a happiness quotient of a team member and to signal a change to avoid possible churn.

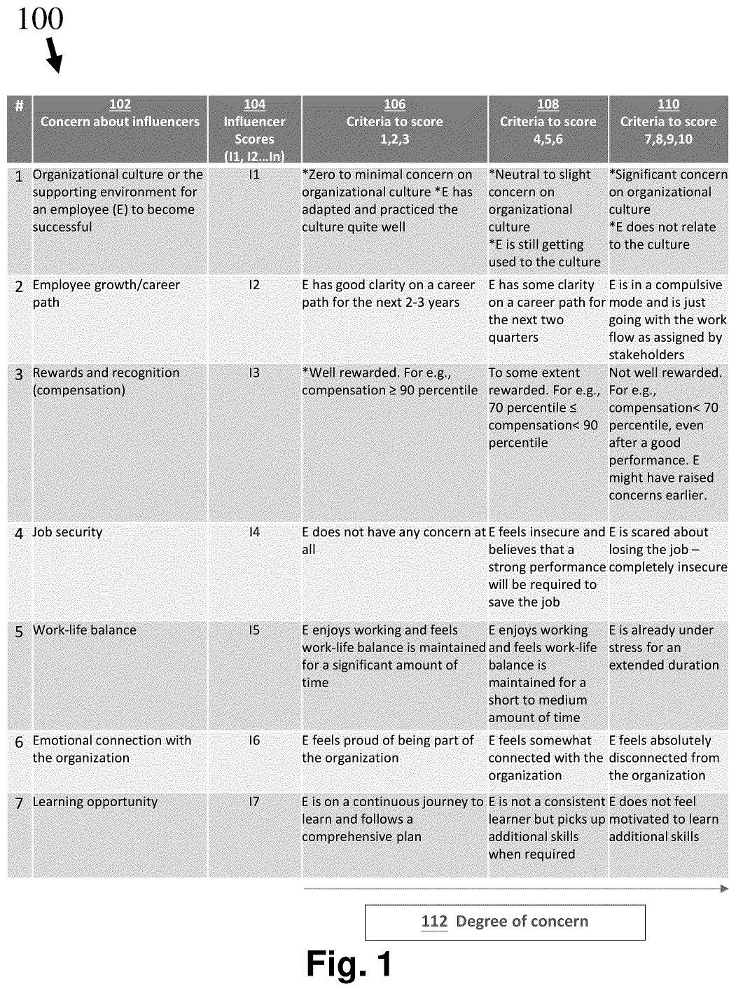

Referring to FIG. 1, a table 100 of one or more input parameters of the E2R model is shown, according to various embodiments of the present disclosure.

In one embodiment, the E2R model quantifies an engagement level of each employee using a set of input parameters shown in the table 100. The table 100 includes 7 types of concerns about influencers 102 and each concern about influencers 102 has its own influencer score 104. In one embodiment, each influencer score 104 in FIG. 1 represents an influencer score for a specific concern about influencer 102. For example, I1 represents an influencer score for an organizational culture or a supporting environment for an employee (E) to become successful. I2 represents an influencer score for an employee growth or a career path. I3 represents an influencer score for rewards and recognition (e.g., compensation). I4 represents an influencer score for job security. I5 represents an influencer score for work-life balance. I6 represents an influencer score for emotional connection with the organization. I7 represents an influencer score for a learning opportunity.

In one embodiment, examples in FIG. 1 represent a distribution of concern about influencers. Each organization may choose a different set of concerns about influencers depending on their context.

In one embodiment, influencer scores I1 to I7 are scored on a scale of 1-10 with 10 being the highest and 1 being the lowest. The scale is built on a fundamental principle, which means the score is higher when there is more concern.

In one embodiment, based on a degree of concern 112, the influencer score 104 ranges from 1 to 10. Each influencer score 104 may have its respective guideline. The guideline for each influencer score 104 is listed in columns 106, 108, and 110. In FIG. 1, influencer scores 104 from 1 to 3 are categorized in column 106; influencer scores 104 from 4 to 6 are categorized in column 108; and influencer scores 104 from 7 to 10 are categorized in column 110. The influencer score 104 may be determined manually by users of the E2R model. For example, human resources in an organization may determine the score manually based on their experience of the degree of concern 112 of each concern about influencers for the organization. In some implementations, the influencer score 104 may be determined automatically at least in part based on available data on organizations or employees. For example, if a third party system has data on employees, the influencer score 104 may be determined from an application programming interface of the third party system. In some examples, the third party system may be another system within a boundary of the system of the E2R model.

In one embodiment, different influencer scores 104 for each concern about influencers 102 have different meanings. In a first example, if the influencer score I1 is a score between 1 and 3 for the organization culture or the supporting environment for an employee to become successful concern, then it means that there is zero to minimal concern on the organizational culture and the employee has adapted and practiced the organizational culture very well. If the influencer score I1 is a score between 4 and 6, then it means that there is neutral to slight concern on the organizational culture and the employee tries to get used to the organizational culture. If the influencer score I1 is a score between 7 and 10, then it means that there is significant concern on the organizational culture, and the employee is not related to the organizational culture.

In a second example, if the influencer score I2 is a score between 1 and 3 for the employee growth and the career path concern, then it means that the employee has good clarity on the career path for the next 2-3 years. If the influencer score I2 is a score between 4 and 6, then it means that the employee has some clarity on the career path for the next two quarters. If the influencer score I2 is a score between 7 and 10, then it means that the employee is in a compulsive mode and is just going with work flow as assigned by stakeholders.

In a third example, if the influencer score I3 is a score between 1 and 3 for the rewards and recognition concern, then it means that the employee is well rewarded, e.g., compensation above 90 percentile. If the influencer score I3 is a score between 4 and 6, then it means that the employee has some rewards, e.g., compensation between 70 percentile and 90 percentile. If the influencer score I3 is a score between 7 and 10, then it means that the employee is not well rewarded, e.g., compensation less than 70 percentile even after a good performance. The employee may raise concerns earlier.

In a fourth example, if the influencer score I4 is a score between 1 and 3 for the job security concern, then it means that the employee does not have any concern at all. If the influencer score I4 is a score between 4 and 6, then it means that the employee feels insecure and believes that a strong performance may be required to save the job. If the influencer score I4 is a score between 7 and 10, then it means that the employee is scared about losing the job, which also means that the employee is completely insecure.

In a fifth example, if the influencer score I5 is a score between 1 and 3 for the work-life balance concern, then it means that the employee enjoys working and feels that the work-life balance is maintained for a significant amount of time. If the influencer score I5 is a score between 4 and 6, then it means that the employee enjoys working and feels that the work-life balance is maintained for a short to medium amount of time. If the influencer score I5 is a score between 7 and 10, then it means that the employee is already under stress for an extended duration.

In a sixth example, if the influencer score I6 is a score between 1 and 3 for an emotional connection with the organization concern, then it means that the employee feels proud of being part of the organization. If the influencer score I6 is a score between 4 and 6, then it means that the employee feels somewhat connected with the organization. If the influencer score I6 is a score between 7 and 10, then it means that the employee feels absolutely disconnected from the organization.

In a seventh example, if the influencer score I7 is a score between 1 and 3 for a learning opportunity concern, then it means that the employee is on a continuous journey to learn and follows a comprehensive plan. If the influencer score I7 is a score between 4 and 6, then it means that the employee is not a consistent learner but picks up additional skills when required. If the influencer score I7 is a score between 7 and 10, then it means that the employee does not feel motivated to learn additional skills.

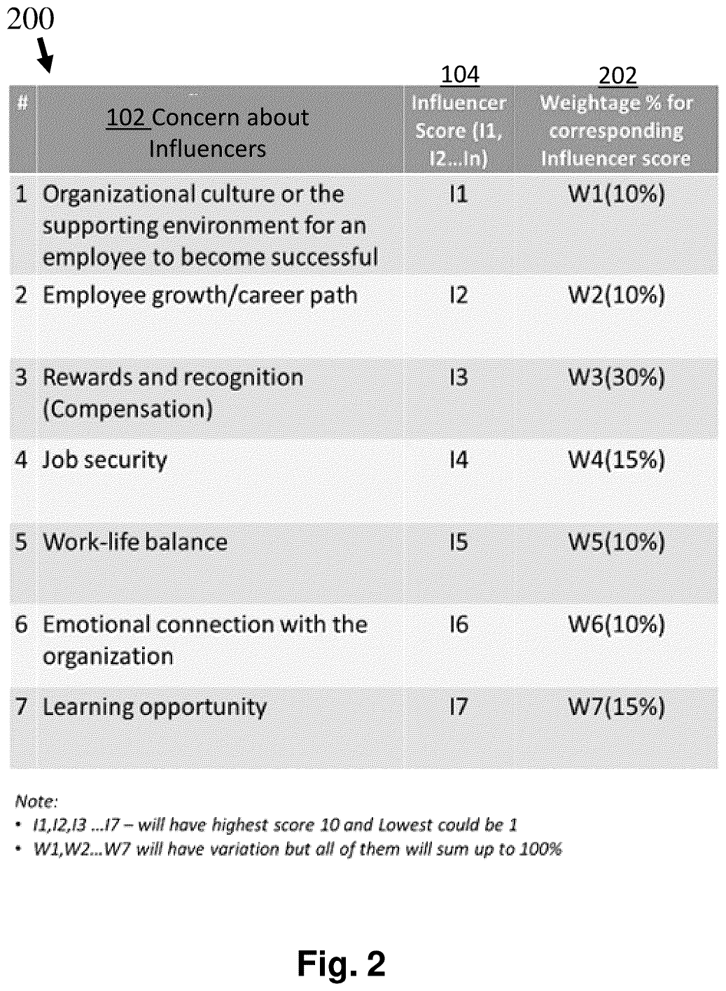

Referring to FIG. 2, a table 200 of weightage 202 for one or more concern about influencers 102 in the E2R model is shown, according to various embodiments of the present disclosure.

In one embodiment, each concern about the influencer 102 in FIG. 1 is awarded a corresponding weightage 202. The weightage 202 may vary depending on situations (e.g., internal factors or external factors) and on a case-by-case basis. For example, job security concern related to the influencer score I4 may be more important for a returning employee after a long break.

In one embodiment, in FIG. 2, each influencer score 104 has a respective weightage 202. For example, the influencer score I1 has a weightage W1; the influencer score I2 has a weightage W2; the influencer score I3 has a weightage W3; the influencer score I4 has a weightage W4; the influencer score I5 has a weightage W5; the influencer score I6 has a weightage W6; and the influencer score I7 has a weightage W7. The weightages from W1 to W7 may have variations. All weightages from W1 to W7 add up to 100%.

In one embodiment, a sum of each influencer score 104 multiplied by its corresponding weightage 202 may be a total score of concern (S), which may be used to quantify the concern of an employee. The total score of concern (S) may be calculated in Equation 1 below:

S=(W1×I1)+(W2×I2)+(W3×I3)+(W4×I4)+(W5×I5)+(W6×I6)+(W7×I7) (Equation 1)

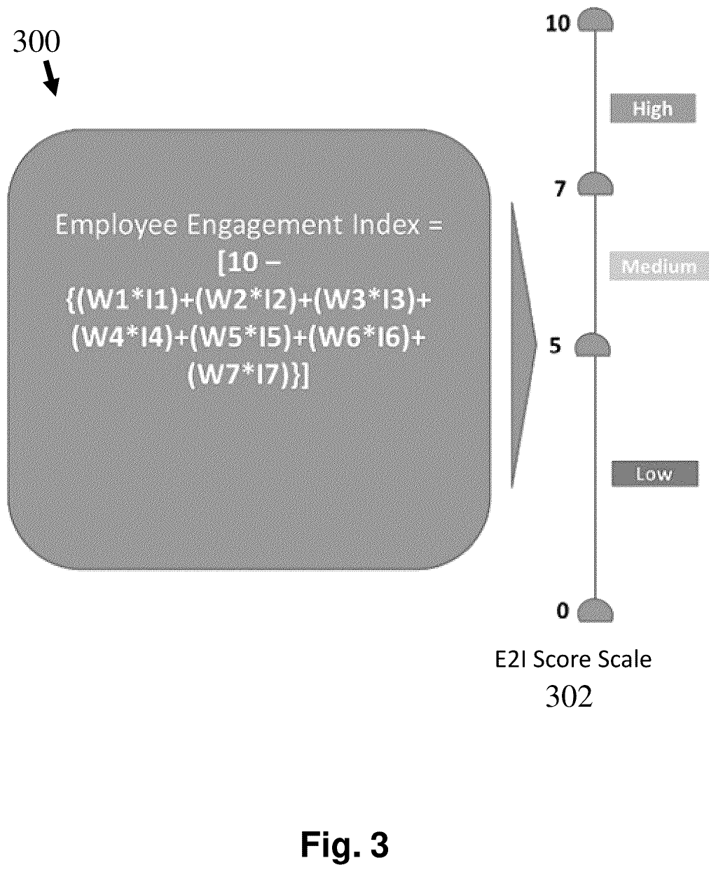

Referring to FIG. 3, a calculation of employee engagement index (E2I) score 300 and an E2I score scale 302 is shown, according to various embodiments of the present disclosure.

In one embodiment, the E2I score 300 may be calculated by deducting the total score of concern (S) from 10. Therefore, the employee E2I score 300 may be calculated as in Equation 2 below:

E2I=10−S, wherein S=[(W1×I1)+(W2×I2)+(W3×I3)+(W4×I4)+(W5×I5)+(W6×I6)+(W7×I7)] (Equation 2)

In one embodiment, the E2I score 300 may be considered low if it is between 0 and 5 on the E2I score scale 302; the E2I score 300 may be considered medium if it is between 5 and 7 on the E2I score scale 302; and the E2I score 300 may be considered high if it is between 7 and 10 on the E2I score scale 302.

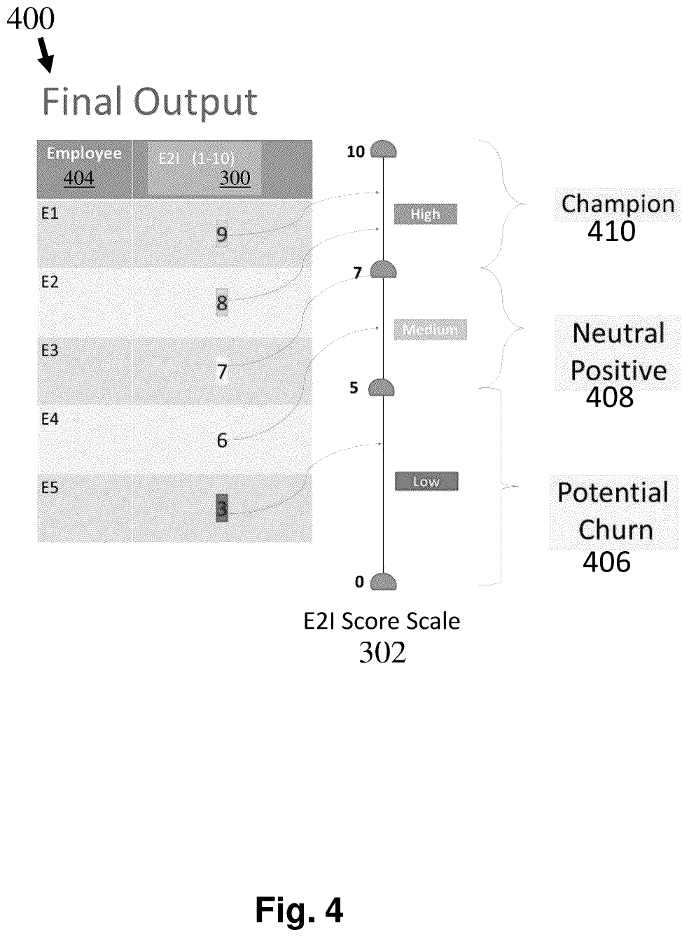

Referring to FIG. 4, a table 400 including one or more employees 404 with employee engagement index (E2I) score 300 is shown, according to various embodiments of the present disclosure.

In one embodiment, the E2I score 300 is calculated for each employee 404 on the table 400. For example, employee E1 may have a E2I score of 9; employee E2 may have a E2I score of 8; employee E3 may have a E2I score of 7; employee E4 may have a E2I score of 6; and employee E5 may have a E2I score of 3.

In one embodiment, each of the employees may be mapped to one or more of a plurality of categories based on its E2I score 300. Higher E2I scores (e.g., 8-10) are mapped to a category of “champion” 410. Medium E2I scores (e.g., 5-7) are mapped to a category of “neutral positive” 408. Lower E2I scores (e.g., less than 5) are mapped to a category of “potential churn” 406.

For example, employee E1 having a E2I score of 9 may be in the category of “champion” 410; employee E2 having a E2I score of 8 may be in the category of “champion” 410; employee E3 having a E2I score of 7 may be in the category of “neutral positive” 408; employee E4 having a E2I score of 6 may be in the category of “neutral positive” 408; and employee E5 having a E2I score of 3 may be in the category of “potential churn” 406.

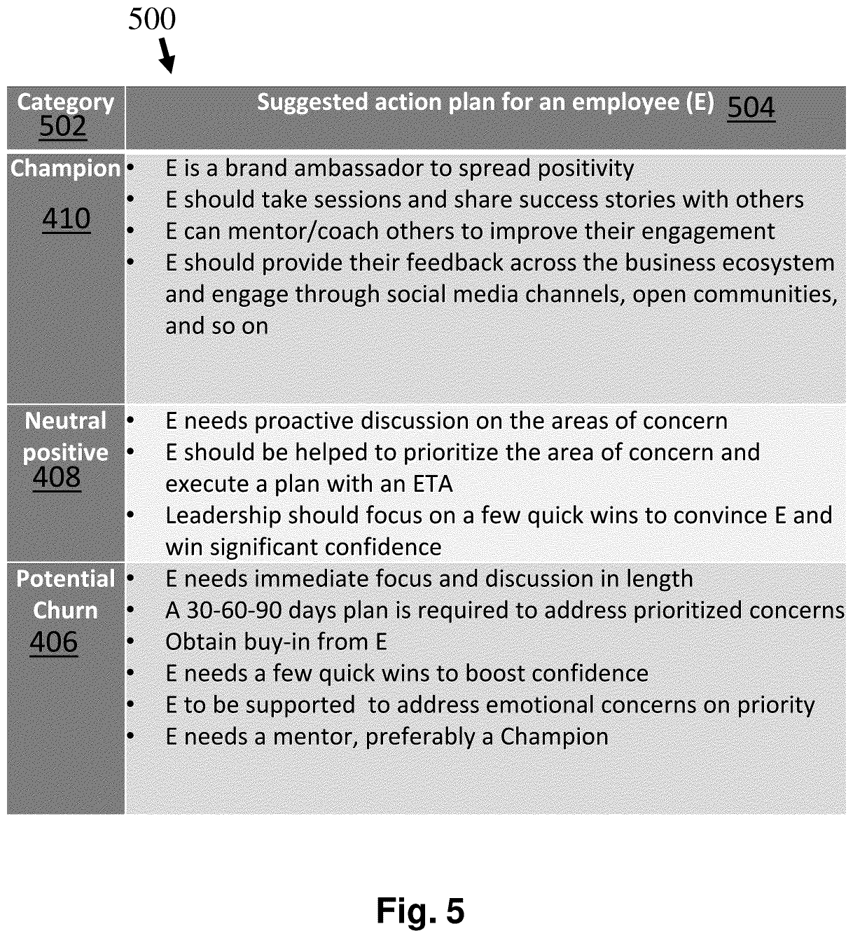

Referring to FIG. 5, a table 500 including one or more categories 502 with a suggested action plan for an employee 504 is shown, according to various embodiments of the present disclosure.

In one embodiment, the table 500 shows one or more categories 502 including the champion 410, the neutral positive 408, and the potential churn 406, which are discussed above in FIG. 4. The table 500 shows a suggested action plan 504 for each employee in each category 502.

In one embodiment, the category of potential churn 406 may need the highest amount of attention with active dialogue and may be immediately guided for a next step; the category of neutral positive 408 may need attention and may need to focus on quick wins to build immediate trust; and the category of champion 410 may be leveraged in a best possible way to ripple positivity and improve employee engagement.

In a first example, a suggested action plan 504 for an employee who is in the category of champion 410 may indicate that the employee is a brand ambassador to spread positivity; the employee should take sessions and share success stories with others; the employee should mentor or coach others to improve their engagement; and the employee should provide their feedback across a business ecosystem and engage through social media channel; and open communities.

In a second example, a suggested action plan 504 for an employee who is in the category of neutral positive 408 may indicate that the employee may need a proactive discussion on the areas of concern; the employee may need some help to prioritize the area of concern and execute a plan with an ETA; and leadership should focus on small accomplishments of the employee to convince the employee and gain significant confidence.

In a third example, a suggested action plan 504 for an employee who is in the category of potential churn 406 may indicate that the employee may need immediate focus and discussion in length; a plan of 30-60-90 days may be required to address prioritized concerns; some commitment from the employee may need to be obtained; the employee may need few small accomplishments to boost confidence; the employee may need to be supported to address emotional concerns on priority; and the employee may need a mentor from the category of champion 410.

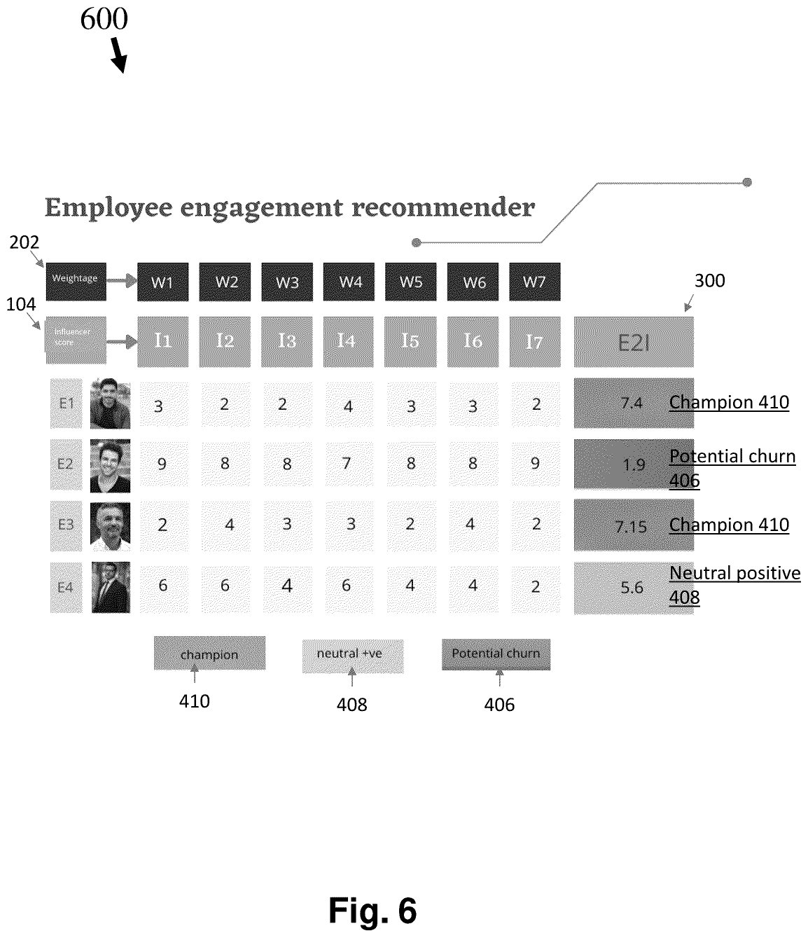

Referring to FIG. 6, a graphical user interface (GUI) 600 including the weightage 202, the influencer score 104, and the E2I score 300 is shown, according to various embodiments of the present disclosure.

In one embodiment, the GUI 600 shows the weightage 202, the influencer score 104, and the E2I score scale 302 discussed above. Users of the GUI 600 may manually provide input data such as weightages 202 and the influencer score 104. For example, human resources in an organization may manually input weightages 202 for each respective influencer score from I1 to I7 based on their experience in the organization. In some embodiments, as discussed above, the users of the GUI 600 may automatically receive the weightages 202 at least in part based on available data on organizations in a third party system. For example, if a third party system has data on the organization, the weightages 202 may be determined from an application programming interface of the third party system. After receiving the input data such as weightages 202 and influence scores 104 in the GUI 600, output data such as E2I score and categorical data for each employee may be calculated and displayed on the GUI 600.

For example, the employee E1 may have input data for its influencer scores 104, e.g., an influencer score I1 for E1 is 3, an influencer score I2 for E1 is 2, an influencer score I3 for E1 is 5, an influencer score I4 for E1 is 4, an influencer score I5 for E1 is 3, an influencer score I6 for E1 is 3, and an influencer score I7 for E1 is 2. As discussed above, the influencer scores from I1 to I7 may be provided manually by users of the GUI 600 or automatically by a third party system, e.g., an employee performance monitor system. Therefore, after receiving the input data for employee E1, output data such as E2I score and categorical data are calculated and displayed on the GUI 600. In this example, the E2I score 302 for the employee E1 is 7.4, which is in the category of champion 410.

In a second example, the employee E2 may input data for its influencer scores 104, e.g., an influencer score I1 for E2 is 9, an influencer score I2 for E2 is 8, an influencer score I3 for E2 is 8, an influencer score I4 for E2 is 7, an influencer score I5 for E2 is 8, an influencer score I6 for E2 is 8, and an influencer score I7 for E2 is 9. Therefore, after receiving the input data for employee E2, output data such as E2I score and categorical data are also calculated and displayed on the GUI 600. In this example, the E2I score 302 for the employee E2 is 1.9, which is in the category of potential churn 406.

In a third example, the employee E3 may input data for its influencer scores 104, e.g., an influencer score I1 for E3 is 2, an influencer score I2 for E3 is 4, an influencer score I3 for E3 is 3, an influencer score I4 for E3 is 3, an influencer score I5 for E3 is 2, an influencer score I6 for E3 is 4, and an influencer score I7 for E3 is 2. Therefore, after receiving the input data for employee E3, output data such as E2I score and categorical data are also calculated and displayed on the GUI 600. In this example, the E2I score 302 for the employee E3 is 7.15, which is in the category of champion 410.

In a fourth example, the employee E4 may input data for its influencer scores 104, e.g., an influencer score I1 for E4 is 6, an influencer score I2 for E4 is 6, an influencer score I3 for E4 is 4, an influencer score I4 for E4 is 6, an influencer score I5 for E4 is 4, an influencer score I6 for E4 is 4, and an influencer score I7 for E4 is 2. Therefore, after receiving the input data for employee E4, output data such as E2I score 302 and categorical data are also calculated and displayed on the GUI 600. In this example, the E2I score 302 for the employee E4 is 5.6, which is in the category of neutral positive 408.

In one embodiment, the output data displayed by GUI 600 may allow the user to easily understand what plans that the employee may need to maintain engagement. For example, in the first example discussed above, the E2I score 302 for the employee E1 is 7.4, which is in the category of champion 410. The user of the GUI 600 may be a human resource manager in an organization and the human resource manager may have meetings with the organization's employees to suggest one or more action plans, which is discussed above with respect to FIG. 5, based on the categorical data provided by the GUI 600.

In one embodiment, as shown in FIG. 6, the weightages 202 are located at the first row of the GUI 600; symbols for the influencer scores 104 are located at the second row of the GUI 600; and influencer scores for each employee are located from the third row to the sixth row of the GUI 600. It is noted that the rows for the weightages 202, the symbols for the influencer scores 104, and the influencer scores for each employee may be in a different order.

In one embodiment, as shown in FIG. 6, the right column is categorical data 300 for each employee. Each category may be represented, but is not limited to, in a specific color. For example, the champion category 410 may be represented in green; the neutral positive category 408 may be represented in yellow; and the potential churn category may be represented in red. Such a color scheme can assist the GUI user to quickly identify employees at risk of leaving an organization. In some embodiments, the influencer scores can be similar color-coded.

In one embodiment, as shown in FIG. 6, the left column may represent the employee's name or employee's identification. For example, employee's identification in the left column may be E1, E2, E2, or E4. In some embodiments, each employee may have a profile picture next to the employee's identification. Many employees can be displayed simultaneously; for example, ten, twenty, thirty or more employees may be displayed, each in a different row or column.

In one embodiment, the GUI 600 may provide clear business insights of employee engagement level of each employee in an organization. Therefore, the human resource manager in the organization may be benefited from the categorical data and the suggested action plans from the GUI 600 as a guidance of the employee engagement in the organization. Advantageously, the matrix configuration of GUI 600 (where each row is an employee and each column is a score associated with a particular influencer) provides the GUI user with a comprehensive view of the individual factors that result in each employee being placed in a particular category and allows for easier editing of scores and comparisons of employees to one another.

In one embodiment, the GUI 600 includes the categorical data and the one or more action plans, which is discussed above in FIG. 5, may be auto populated depending on the category of employee (e.g., champion 410, neutral positive 408, or potential churn 406.) In some embodiments, a trend analysis of the employee engagement of an organization may be performed by looking at the entire employee population of an organization.

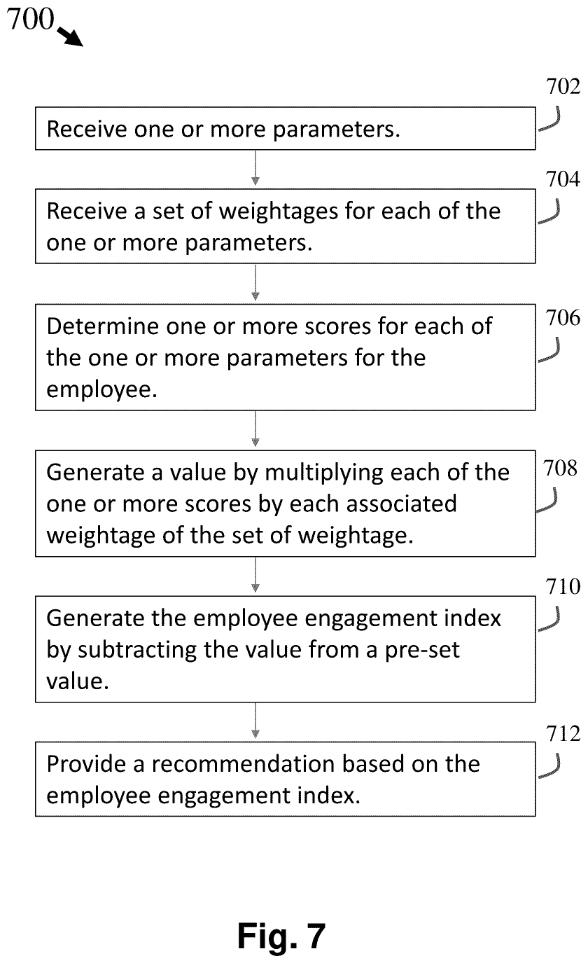

Referring to FIG. 7, a flowchart diagram 700 of generating an employee engagement index is shown, according to various embodiments of the present disclosure.

At step 702, one or more parameters are received. At step 704, a set of weightages for each of the one or more parameters are received. At step 706, one or more scores for each of the one or more parameters for the employee are determined. At step 708, a value is generated by multiplying each of the one or more scores by each associated weightage of the set of weightages. At step 710, the employee engagement index is generated by subtracting the value from a pre-set value. The pre-set value may be determined by a user of the system or a third party system. At step 712, a recommendation is provided based on the employee engagement index.

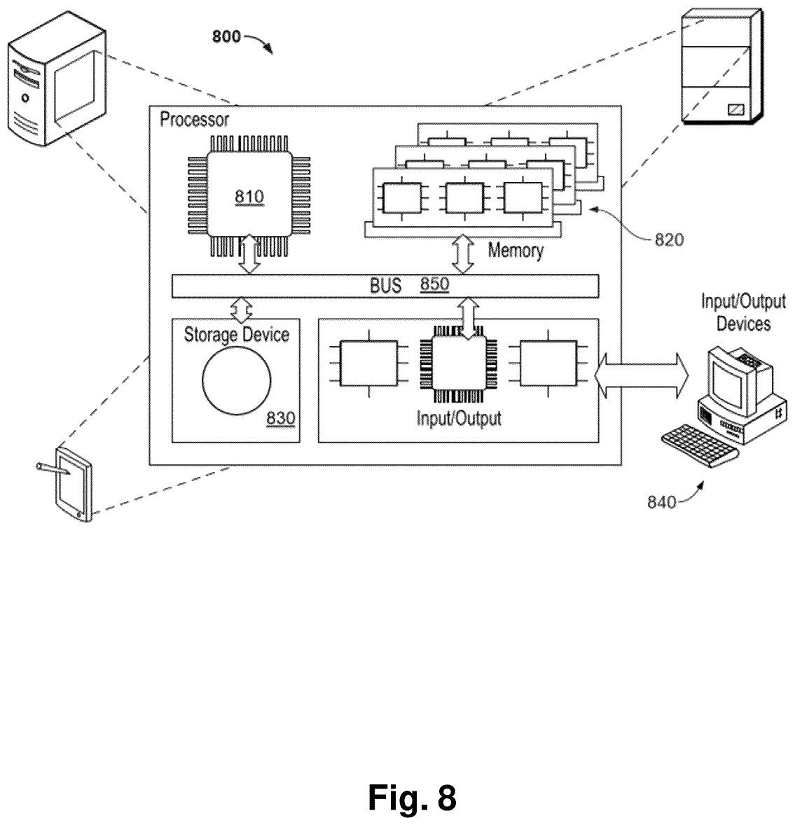

An example of a type of user's computer is shown in FIG. 8, which shows a schematic diagram of a generic computer system 800. The employee engagement recommender graphical user interface (GUI) 600 described above may be implemented as a software application and the software application may be used in the user's computer. The user's computer may be a desktop computer or a laptop.

The system 800 may be used for the operations described in association with any of the method, according to one implementation. The functions and the algorithms described above may be performed in the software application in the user's computer. For example, a user of the GUI 600 may use the system 800 to access the GUI 600. The user may input data such as one or more weightages 202 and influencer scores 104 for each employee of an organization or the user may receive input data from the third party system to the system 800. After the GUI 600 in the system 800 receives the input data, the GUI in the system 800 output data for the user, e.g., the E2I score 300 for employee E1 is 7.4, as discussed above in FIG. 6. The system 800 includes a processor 810, a memory 820, a storage device 830, and an input/output device 840. Each of the components 810, 820, 830, and 840 is interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information, e.g., the GUI 600, for a user interface on the input/output device 840.

As discussed earlier, the processor 810 may be used to calculate the E2I score 300 for each employee based on its weightages 202 and influencer scores 104. The processor 810 may be used to create a model, e.g., the E2R model, based on user's input data or historical data from a third party system for the weightages 202 and influencer scores 104 of each employee in an organization, as discussed earlier. The processor 810 may execute the processes, formula, and algorithm in the present disclosure.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device. The storage device 830 may store data for each employee such as weightages 202 and influencer scores 104 as discussed earlier. The storage device 830 may store one or more output data such as the E2I score 300 for each employee discussed earlier.

The input/output device 840 provides input/output operations for the system 800. In one implementation, the input/output device 840 includes a keyboard and/or pointing device. In another implementation, the input/output device 840 includes a display unit for displaying graphical user interfaces, e.g., the GUI 600.

While this specification contains many specific implementation details, these should not be construed as limitations on the scope of what may be claimed, but rather as descriptions of features that may be specific to particular embodiments.

It is to be understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventor did not consider such subject matter to be part of the disclosed inventive subject matter.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only.

Obviously, numerous modifications and variations are possible in light of the above teachings. It is therefore to be understood that within the scope of the appended claims, embodiments of the present disclosure may be practiced otherwise than as specifically described herein.

What is claimed is:

1. A system for generating an employee engagement recommender model for determining an employee engagement index score of an employee in an organization, the system comprising:
one or more processors; and
a memory coupled with the one or more processors wherein the one or more processors executes a plurality of modules stored in the memory and wherein the plurality of modules comprises:
a user input module that, when executed, receives input data comprising a plurality of weightages and a plurality of influencer scores for a plurality of employees;
an employee engagement recommender module that, when executed, generates an employee engagement index score for each employee based on the plurality of weightages and the plurality of influencer scores associated with the employee; and
a user interface module that, when executed, generates a graphical user interface that displays output data comprising the employee engagement index score of each employee and a category associated with each employee, wherein the graphical user interface is configured to (i) create and display an employee engagement user interface element for each employee by positioning within the graphical user interface an identifier associated with such employee in correlation with a visual representation of the employee engagement index score of such employee and a visual representation of the associated category of such employee and (ii) spatially arraying the employee engagement user interface elements within the graphical user interface to facilitate comparison of the plurality of employees.

2. The system of claim 1, wherein a user of the system manually inputs the one or more weightages and the one or more influencer scores.

3. The system of claim 1, wherein a third party system provides the one or more weightages, the third party system including data regarding the organization.

4. The system of claim 1, wherein the one or more categories for the one or more employees include a champion category, a neutral positive category, and a potential churn category.

5. The system of claim 1, wherein each of the one or more employment engagement index scores has a corresponding category in the one or more categories for the one or more employees.

6. The system of claim 1, wherein each of the one or more categories has a color different than each other category in the one or more categories.

7. The system of claim 1, wherein the pre-set value is determined by a user of the system.

8. The system of claim 1, wherein the pre-set value is determined by a third party system, the third party system including data regarding the organization.

9. The system of claim 1, wherein one or more action plans are suggested based on the one or more categories.

10. The system of claim 1, wherein the employee recommender module further generates a value by multiplying each of the one or more influencer scores by each associated weightage of the one or more weightages.

11. The system of claim 1, wherein the employee recommender module further generates the employee engagement index score by subtracting the value from a pre-set value.

12. A method for generating an employee engagement recommender model for determining an employee engagement index score of an employee in an organization, the method comprising:
receiving, by a processor, a plurality of influencer scores for a plurality of employee;
receiving, by the processor, a plurality of weightages for each of the plurality of influencer scores, the plurality of weightages defined by the organization;
generating, by the processor, an employee engagement index score for each employee based on the plurality of weightages and the plurality of influencer scores associated with the employee; and
generating, by the processor, a graphical user interface that displays output data comprising the employee engagement index score of each employee and a category associated with each employee.

13. The method of claim 12, wherein a user manually inputs the plurality of weightages and the plurality of influencer scores.

14. The method of claim 12, wherein a third party system provides the plurality of weightages, the third party system including data regarding the organization.

15. The method of claim 12, wherein the category is in one or more categories for the employee, the one or more categories including a champion category, a neutral positive category, and a potential churn category.

16. The method of claim 15, wherein each of the one or more categories has a color different than other category in the one or more categories.

17. The method of claim 15, wherein one or more action plans are suggested based on the one or more categories.

18. The method of claim 12, wherein the pre-set value is determined by a user.

19. The method of claim 12, wherein the pre-set value is determined by a third party system, the third party system including data regarding the organization.

20. A non-transitory computer-readable storage medium storing computer-readable instructions that, when executed by a computer, cause the computer to perform a method, the method comprising:
receiving, by a processor, a plurality of influencer scores for a plurality of employee;
receiving, by the processor, a plurality of weightages for each of the plurality of influencer scores, the plurality of weightages defined by the organization;
generating, by the processor, an employee engagement index score for each employee based on the plurality of weightages and the plurality of influencer scores associated with the employee; and
generating, by the processor, a graphical user interface that displays output data comprising the employee engagement index score of each employee and a category associated with each employee.
